(19) United States
(12) Patent Application Publication
(10) Pub. No.: US 2017/0297510 A1
(43) Pub. Date: Oct. 19, 2017

(54) ROOF FOR VEHICLE

(71) Applicant: Hyundai Motor Company, Seoul (KR)

(72) Inventors: Moon Seop Lee, Yongin (KR); Jeong Min Cho, Suwon-Gyeonggi-do, (KR); Kyu Nam Jeon, Hwaseong (KR)

(21) Appl. No.: 15/273,070

(22) Filed: Sep. 22, 2016

(30) Foreign Application Priority Data
Apr. 18, 2016 (KR) 10-2016-0047132

(51) Int. Cl. B60R 13/08; B62D 25/06; B62D 29/04

(52) U.S. Cl. CPC B60R 13/0815; B62D 29/046; B62D 25/06; B62D 29/043

(57) ABSTRACT

A roof for a vehicle is provided. The roof includes a roof panel that is formed of a composite material, a reinforcing frame that is attached onto a lower surface of the roof panel and formed of a composite material and a plurality of first reinforcing members that are connected to the reinforcing frame within the reinforcing frame and disposed to be continuously spaced apart from each other. A plurality of second reinforcing members are connected to the reinforcing frame while intersecting with the first reinforcing members and are disposed to be continuously spaced apart from each other to form a truss structure together with the first reinforcing members within the reinforcing frame.

### CROSS REFERENCE TO RELATED APPLICATION

The present application claims priority to Korean Patent Application No. 10-2016-0047132, filed Apr. 18, 2016, the entire contents of which is incorporated herein for all purposes by this reference.

### BACKGROUND

### 1. Technical Field of the Invention

The present invention relates to a roof for a vehicle, and more particularly, to a roof capable of having improved noise, vibration, harshness (NVH) performance by attaching a reinforcing body forming a truss structure to a roof panel formed of a composite material to secure rigidity of the roof panel.

### 2. Description of the Related Art

Generally, an existing roof for a vehicle with a body formed of carbon fiber reinforced plastic (CFRP) has used a roof panel having a form with a greater thickness than steel. A center roof rail that forms a frame and has a planar shape, that increases cost and weight of the roof for a vehicle. Additionally, when a roof formed of CFRP is applied to a roof for a vehicle with a body formed from steel, corrosion due to a potential difference may occur at a bonded portion between the steel and the CFRP. Therefore, a new roof that decreases a cost and a weight and may be applied to the vehicle body formed of CFRP and steel is required.

The above information disclosed in this is merely for assisting in the understanding for the background of the present invention and therefore it may contain information that does not form the prior art that is already known in this country to a person of ordinary skill in the art.

### SUMMARY

The present invention provides a roof for a vehicle capable of having improved NVH performance by attaching a reinforcing body forming a truss structure to a roof panel formed of a composite material to secure rigidity of the roof panel.

According to an exemplary embodiment of the present invention, a roof for a vehicle may include a roof panel formed of a composite material, a reinforcing frame coupled to a lower surface of the roof panel and formed of a composite material, a plurality of first reinforcing members coupled to the reinforcing frame within the reinforcing frame and continuously spaced apart from each other and a plurality of second reinforcing members connected to the reinforcing frame while intersecting with the first reinforcing members and continuously spaced apart from each other to form a truss structure together with the first reinforcing members within the reinforcing frame.

The reinforcing frame may include a pair of horizontal axes adjacent to each other that extend in a width direction of the vehicle and a pair of vertical axes that each connect end portions of the pair of horizontal axes to each other. The first reinforcing members may connect the pair of horizontal axes to each other and form a predetermined angle with respect to the horizontal axes. The second reinforcing members may connect the pair of horizontal axes to each other while intersecting with the first reinforcing members. The roof panel may be formed of a composite material that contains an insulating material

A thickness of a cross section of the reinforcing frame in a vertical direction may be greater than the thickness of the cross sections of the first and second reinforcing members in the vertical direction. Upper ends of the reinforcing frame, the first reinforcing member, and the second reinforcing member may abut the lower surface of the roof panel. A pair of first and second reinforcing members that intersect with each other may form a quadrangle together with a pair of surrounding first and second reinforcing members adjacent thereto, and form a triangle together with the horizontal axis and the vertical axis of the reinforcing frame. The roof panel, the reinforcing frame, the first reinforcing members, and the second reinforcing members may be integrally molded with each other. The reinforcing frame, the first reinforcing members, and the second reinforcing members may form a reinforcing body. A plurality of reinforcing bodies may be coupled to the lower surface of the roof panel in a length direction of the roof panel when the plurality of reinforcing bodies are spaced apart from each other.

The roof for a vehicle may further include a supplementing body connected to at least one of the pair of horizontal axes to supplement the rigidity of the roof panel. The supplementing body may include a first supplementing frame that forms a quadrangular shape together with the horizontal axis. The first supplementing members may intersect with each other to connect vertices of the supplementing frame to each other. The second supplementing members may intersect with each other to connect sides of the supplementing frame to each other. The supplementing body may include a supplementing frame that forms a semicircular shape together with the horizontal axis. The first supplementing members may extend radially from the center of the horizontal axis. The second supplementing members may form a semicircular shape together with the horizontal axis, may have a diameter less than the diameter of the supplementing frame, and may share the center with the supplementing frame.

The supplementing body may include a supplementing frame with a first end portion connected to a first side of the horizontal axis and a second end portion connected to a second side of the horizontal axis. A rail shape may be bent twice at a right angle, a plurality of first supplementing members may be continuously spaced apart from each other to form a predetermined angle with respect to the horizontal axis along the supplementing frame within the supplementing frame and a plurality of second supplementing members continuously spaced apart from each other may intersect with the first supplementing members to form a truss structure together with the first supplementing members within the supplementing frame. The supplementing body may include a supplementing frame with a first end portion connected to a first side of the horizontal axis and a second end portion connected to a second side of the horizontal axis and may have an arched (e.g., a curved geometric shape) rail shape. A plurality of first supplementing members may connect lines of the rail spaced apart from each other by a predetermined distance to each other within the supplementing frame and may be continuously spaced apart from each other along the supplementing frame. A plurality of second supplementing members may be continuously spaced apart from each other while intersecting with the first supplementing members to form a truss structure together with the first supplementing members within the supplementing frame.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A and 1B are exemplary views illustrating a roof panel and a reinforcing body according to an exemplary embodiment of the present invention;

FIG. 2 is an exemplary view illustrating a roof for a vehicle according to an exemplary embodiment of the present invention;

FIG. 3 is an exemplary side view illustrating the roof panel and the reinforcing body according to an exemplary embodiment of the present invention;

FIG. 4 is an exemplary view illustrating a structure in which a plurality of reinforcing bodies are connected to the roof panel according to an exemplary embodiment of the present invention;

FIG. 5 is an exemplary view illustrating a form in which a reinforcing body and a supplementing body are connected to the roof panel according to an exemplary embodiment of the present invention;

FIG. 6 is an exemplary view illustrating a form in which a reinforcing body and a supplementing body are connected to the roof panel according to an exemplary embodiment of the present invention;

FIG. 7 is an exemplary view illustrating a form in which a reinforcing body and a supplementing body are connected to the roof panel according to an exemplary embodiment of the present invention;

FIG. 8 is an exemplary view illustrating a form in which a reinforcing body and a supplementing body are connected to the roof panel according to an exemplary embodiment of the present invention;

FIG. 9 is an exemplary view illustrating a form in which a reinforcing body and a supplementing body are connected to the roof panel according to an exemplary embodiment of the present invention;

FIG. 10 is an exemplary view illustrating a form in which a reinforcing body and a supplementing body are connected to the roof panel according to an exemplary embodiment of the present invention; and

FIG. 11 is an exemplary view illustrating a form in which a reinforcing body and a supplementing body are connected to the roof panel according to an exemplary embodiment of the present invention.

### DETAILED DESCRIPTION

The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims

A part irrelevant to the description will be omitted to clearly describe the present disclosure, and the same or similar constituent elements will be designated by the same reference numerals throughout the specification. Terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own disclosure by the best method.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

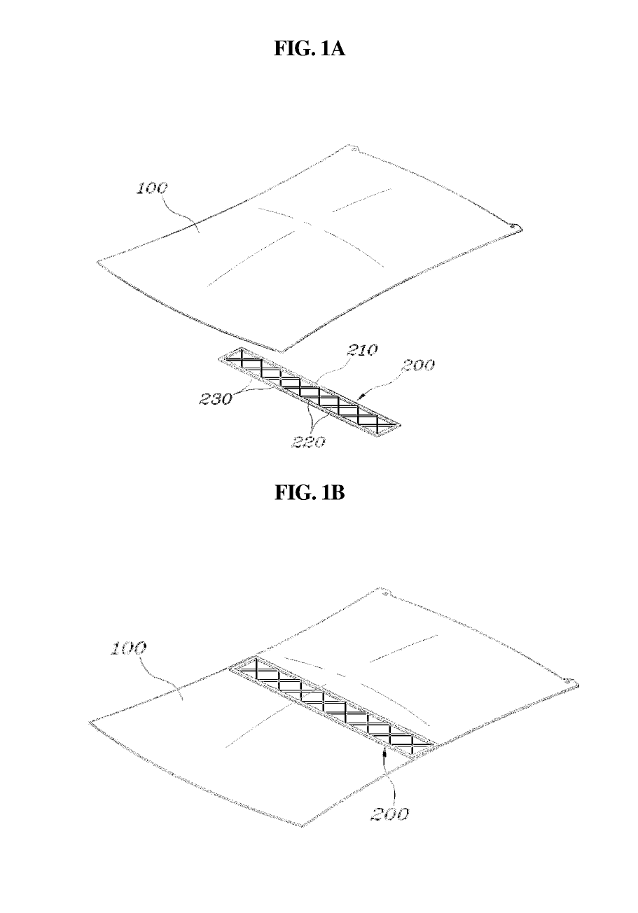

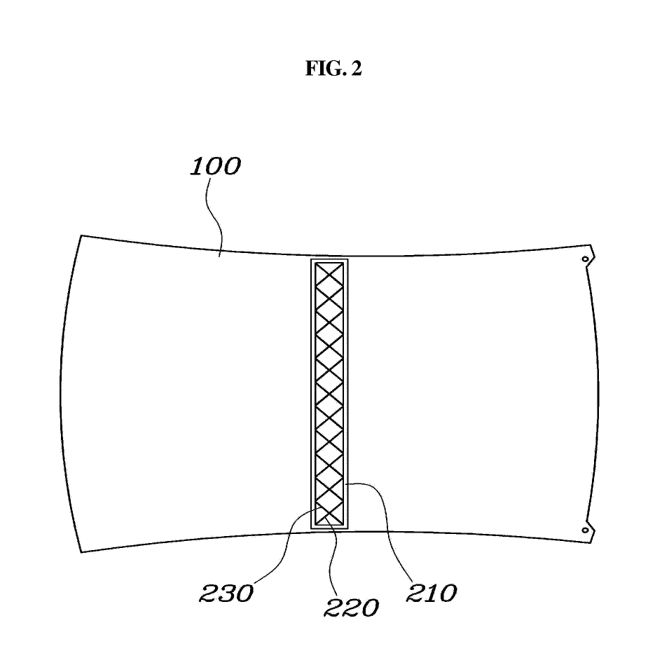

A roof for a vehicle according to the present invention may include a roof panel 100 formed of a composite material, a reinforcing frame 210 coupled to a lower surface of the roof panel 100 and formed of a composite material, a plurality of first reinforcing members 220 connected to the reinforcing frame 210 within the reinforcing frame 210 and continuously spaced apart from each other and a plurality of second reinforcing members 230 connected to the reinforcing frame 210 while intersecting with the first reinforcing members 220 and continuously spaced apart from each other to form a truss structure together with the first reinforcing members 220 within the reinforcing frame 210, as illustrated in FIGS. 1A to 2. In particular, the reinforcing frame 210 may include a pair of horizontal axes that extend while facing each other in a width direction of the vehicle and a pair of vertical axes that each connect end portions of the pair of horizontal axes to each other. The first reinforcing members 220 may connect the pair of horizontal axes to each other and form a predetermined angle with respect to the horizontal axes. The second reinforcing members 230 may connect the pair of horizontal axes to each other and intersect with the first reinforcing members 220.

The roof panel 100 may include a plate shape and may be formed of the composite material that contains a resin and a reinforced fiber. The reinforced fiber of the composite material may be a glass fiber with an insulating property. Therefore, a potential corrosion problem that occurs due to a potential difference at a contact portion between the roof panel 100 and a vehicle body, which is a problem occurring when the roof panel 100 is formed of a carbon fiber, may be solved. Additionally, the inexpensive glass fiber may be used and the cost may be reduced. The roof panel 100 may be formed at a thickness less than the thickness of the existing roof panel 100 using the carbon fiber and a weight of the vehicle body may be reduced.

The reinforcing frame 210 may be coupled the lower surface of the roof panel 100 and may provide a frame of the roof panel 100 that secures rigidity of the roof panel. The reinforcing frame 210 may be formed of the composite material, similar to the roof panel 100. For example, a reinforced fiber formed from the composite material may be a carbon fiber. Therefore, the rigidity of the roof panel may be secured and the NVH and strength may be increased to improve durability. The reinforcing frame 210 may include the pair of horizontal axes and the pair of vertical axes to form a quadrangle. The reinforcing frame 210 may be formed in a rectangular shape when a length of the horizontal axis is equal to a width of the roof panel 100 and when a length of the vertical axis is less than that of the horizontal axis to decrease cost and weight of the vehicle body.

The horizontal axes including portions of the reinforcing frame 210 formed in parallel with the width of the roof panel 100 may be formed in a direction parallel with the width direction of the vehicle since they are in parallel with the width of the roof panel 100. The vertical axes, that are portions of the reinforcing frame 210 connect end portions of the pair of horizontal axes facing each other to each other to allow the reinforcing frame 210 to form a closed cross section, may be formed perpendicularly to the width of the roof panel 100. Therefore, the vertical axes may be formed in a direction perpendicular to the width direction of the vehicle.

Furthermore, the plurality of first reinforcing members 220 may be spaced apart from each other while forming a predetermined angle with respect to the horizontal axes or the vertical axes of the reinforcing frame 210 within the reinforcing frame 210. The first reinforcing members 220 may be formed of a composite material that contain a carbon fiber and may be coupled to the lower surface of the roof panel 100 similar to the reinforcing frame 210. The plurality of second reinforcing members 230 may correspond to the first reinforcing members 220 and may be disposed to be spaced apart from each other to form a predetermined angle with respect to the horizontal axes or the vertical axes of the reinforcing frame 210 within the reinforcing frame 210. The second reinforcing members 230 may be formed of a composite material that contain a carbon fiber and may be coupled to the lower surface of the roof panel 100, similar to the reinforcing frame 210 and the first reinforcing members 220. Therefore, rigidity of the roof panel and the NVH may be improved and strength may be increased, thereby to improve durability.

Each of the second reinforcing members 230 may intersect with each of the first reinforcing members 220, to form patterns repeated within the reinforcing frame 210. A pair of first reinforcing member 220 and second reinforcing member 230 may intersect with each other to form a quadrangle together with a pair of surrounding first reinforcing member 220 and an adjacent second reinforcing member 230, and may form a triangle together with the horizontal axis and the vertical axis of the reinforcing frame. In other words, the first reinforcing members 220 and the second reinforcing members 230 may form the truss structure within the reinforcing frame 210. The number of components may be decreased and an assembly property of the components may be improved when the truss structure is formed as described above compared with a reinforcing body formed in a plate shape.

Additionally, the truss structure may be formed with the pair of first reinforcing member 220 and second reinforcing member 230 that intersect with each other to connect portions of the reinforcing frame 210 to each other. For example, both end portions of the first reinforcing member 220 contact both end portions of the second reinforcing member 230 at the reinforcing frame 210, and may improve NVH and durability. As resins may form the composite materials of the roof panel 100, the reinforcing frame 210, the first reinforcing members 220 and the second reinforcing members 230, a thermoplastic resin and a thermosetting resin may be used. However, the resins that form the composite materials are not limited thereto.

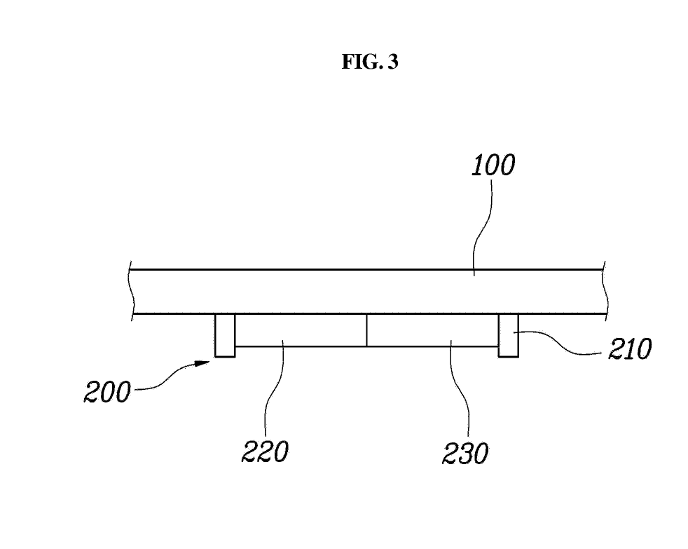

As illustrated in FIG. 3, a difference may be present between a length extended from the lower surface of the roof panel 100 in a downward direction of the reinforcing frame 210 and a length extended from the lower surface of the roof panel 100 in a downward direction of the first reinforcing member 220 and the second reinforcing member 230. Accordingly, the extended length of the reinforcing frame 210 may be greater than the extended length of the first reinforcing member 220 and the second reinforcing member 230. In particular, a frame role of the reinforcing frame 210 for the roof panel 100 may be enhanced to secure rigidity of the roof panel.

Further, the roof panel 100, the reinforcing frame 210, the first reinforcing members 220, and the second reinforcing members 230 may be integrally molded with each other. As described above, the roof panel 100 may be formed of the glass fiber and the reinforcing frame 210. The first reinforcing members 220, and the second reinforcing members 230 may be formed of the carbon fiber and may be integrally molded with each other. In particular, an assembly property may be improved and a cost and a weight may be decreased compared with when the roof panel and the reinforcing body formed in a plate shape are attached to each other using an adhesive. A technology according to the present invention may be applied to a quadrangular panel portion when the surrounding is reinforced by a member. For example, the technology according to the present invention may be applied to a center pillar or a center floor member by a method of an integrally molded panel type member and member type member.

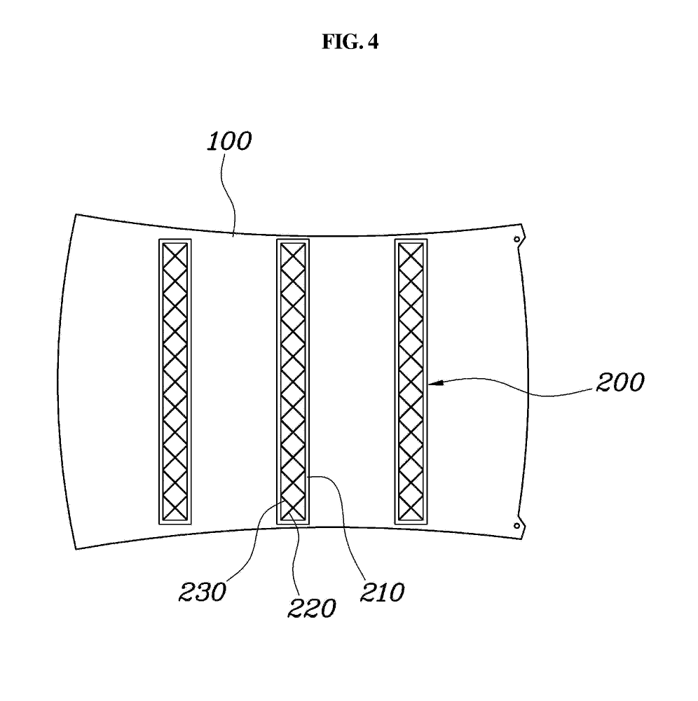

As an exemplary embodiment according to the present invention, as illustrated in FIG. 4, a plurality of reinforcing bodies 200 each including the reinforcing frame 210, the first reinforcing members 220, and the second reinforcing members 230 may be coupled to the lower surface of the roof panel 100 to be spaced apart from each other in a length wise direction of the roof panel 100. The plurality of reinforcing bodies 200 may be disposed to be spaced apart from each other in the length direction of the roof panel 100. The rigidity of the roof panel 100 may be secured and may improve strength of the roof panel 100.

As another exemplary embodiment according to the present invention, the roof for a vehicle may further include a supplementing body 300 connected to at least one of a pair of horizontal axes to supplement rigidity of the roof panel 100. When the rigidity of the roof panel 100 is insufficient using only the reinforcing body 200 including the reinforcing frame 210, the first reinforcing members 220, and the second reinforcing members 230, the supplementing body 300 may be connected to the horizontal axis to improve the rigidity of the roof panel 100. The supplementing body 300 may be connected to one horizontal axis or be connected to multiple horizontal axes. The supplementing body 300 may also be formed of a composite material that may contain a carbon fiber similar to the reinforcing body 200. As a resin formed from a composite material of a supplementing frame 310, a thermoplastic resin and a thermosetting resin may be used. However, the resin constituting the composite material is not limited thereto.

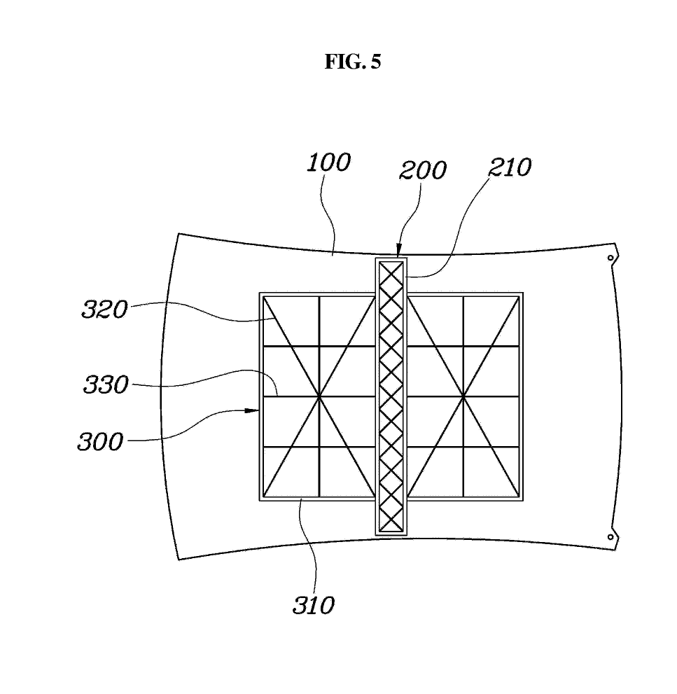

As an exemplary embodiment according to the present invention, the supplementing body 300 may include a first supplementing frame 310 that forms a quadrangular shape together with the horizontal axis, first supplementing members 320 that intersects with each other to connect vertices of the supplementing frame 310 to each other and second supplementing members 330 that intersects with each other to connect sides of the supplementing frame 310 to each other. When the supplementing body 300, a central portion of the supplementing body 300 with which the first supplementing members 320 and the second supplementing members 330 simultaneously intersect are formed in the supplementing frame 310, the rigidity of the roof panel 100 around the central portion may be secured separately from the reinforcing body 200. For example, a plurality of supplementing bodies 300 may be connected to both sides of the horizontal axis, as illustrated in FIG. 5.

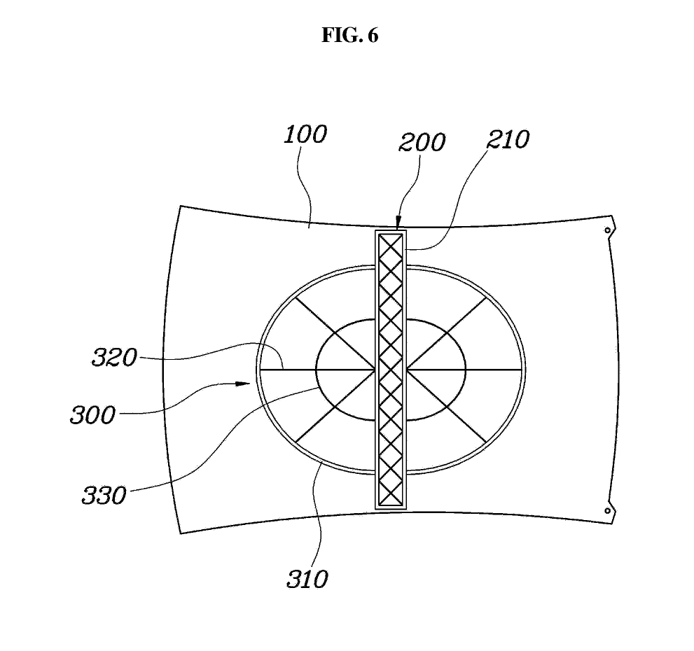

As another exemplary embodiment according to the present invention, the supplementing body 300 may include a supplementing frame 310 that forms a semicircular shape together with the horizontal axis, first supplementing members 320 radially extends from the center of the horizontal axis, and second supplementing members 330 forms a semicircular shape together with the horizontal axis with a diameter less than that of the supplementing frame 310 and shares the center with the supplementing frame 310. The supplementing body 300 shares the center with the reinforcing body 200 and has a form with the first supplementing members 320 radially extended based on the the center. Accordingly, the rigidity of the roof panel 100 around the reinforcing body 200 may be secured. In particular, a plurality of supplementing bodies 300 may be connected to both sides of the horizontal axis, as illustrated in FIG. 6.

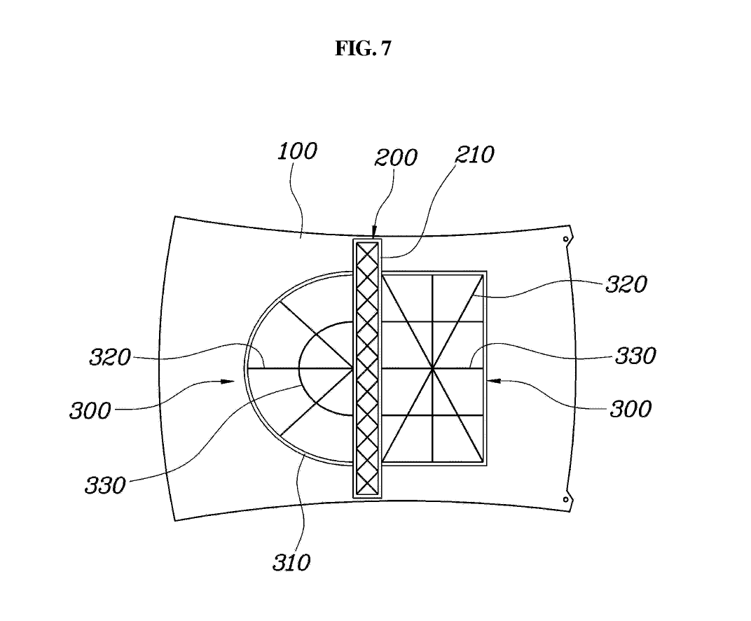

In addition, as illustrated in FIG. 7, the supplementing body 300 including the supplementing frame 310 having the quadrangular shape may be connected to one side and the supplementing body 300 including the supplementing frame 310 having the semicircular shape may be connected to the other side. As still another exemplary embodiment according to the present invention, the supplementing body 300 may include a supplementing frame 310 having a first end portion connected to a first side of the horizontal axis and a second end portion connected to the a second side of the horizontal axis and having a rail shape bent twice at a right angle. A plurality of first supplementing members 320 may be continuously spaced apart from each other to form a predetermined angle with respect to the horizontal axis along the supplementing frame 310 within the supplementing frame 310.

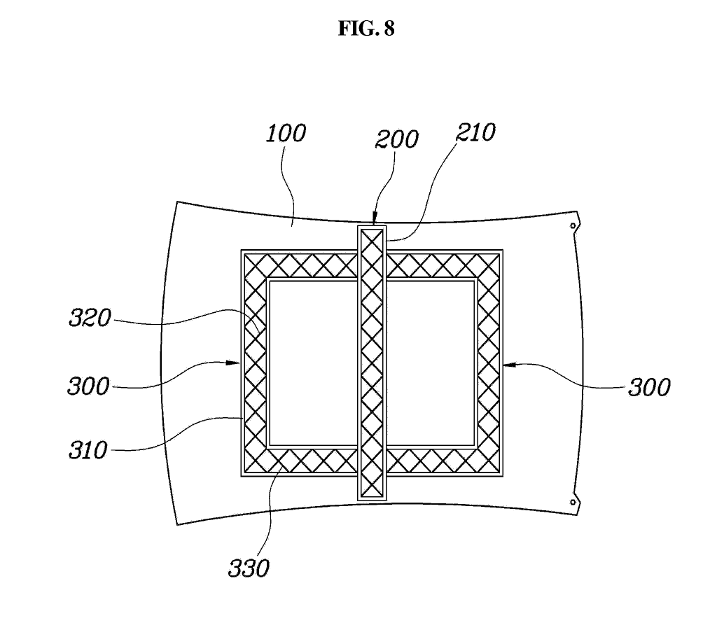

A plurality of second supplementing members 330 may be continuously spaced apart from each other while intersecting with the first supplementing members 320 to form a truss structure together with the first supplementing members 320 within the supplementing frame 310. The supplementing frame 310 may include the rail shape with two lines spaced apart from each other by a predetermined distance starts from a horizontal axis of a first side, may be bent twice and may be disposed at a horizontal axis of a second side. The first supplementing members 320 and the second supplementing members 330 in the supplementing frame 310 may form the truss structure to increase rigidity of the roof panel 100 around the reinforcing body 200, as illustrated in FIG. 8.

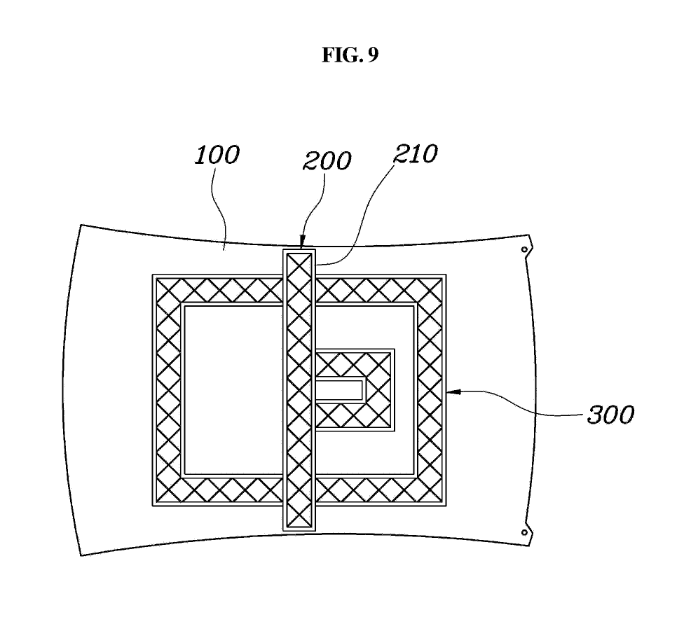

Additionally, as illustrated, in FIG. 9, another supplementing body 300 having a size less than that of the supplementing body 300 may be coupled to the lower surface of the roof panel 100 between the reinforcing body 200 and the supplementing body 300 to increase the rigidity of the roof panel 100. In another exemplary embodiment according to the present invention, the supplementing body 300 may include a supplementing frame 310 having a first end portion connected to a first side of the horizontal axis and a second end portion connected to a second side of the horizontal axis and may have an arched rail shape. A plurality of first supplementing members 320 connecting lines of the rail may be spaced apart from each other by a predetermined distance to each other within the supplementing frame 310 and may be disposed to be continuously spaced apart from each other along the supplementing frame 310. A plurality of second supplementing members 330 may be continuously spaced apart from each other while intersecting with the first supplementing members 320 to form a truss structure together with the first supplementing members 320 within the supplementing frame 310.

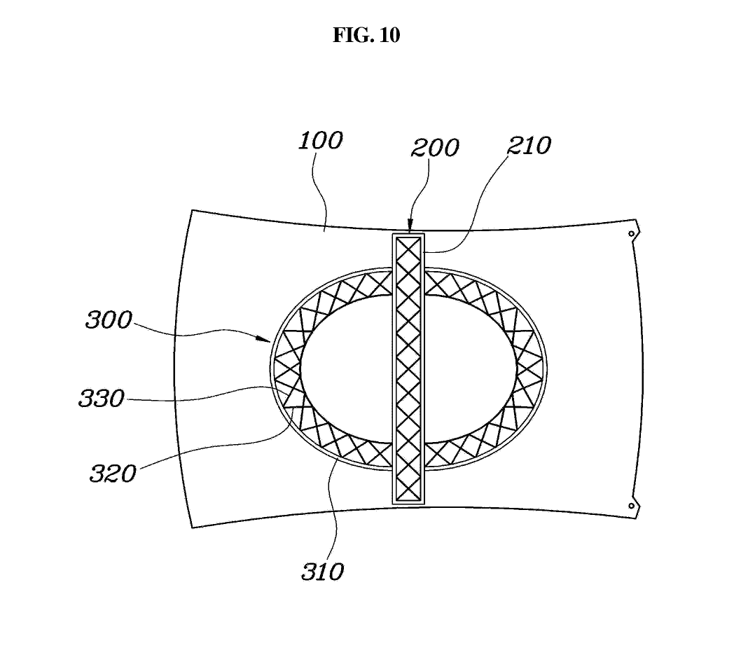

The supplementing frame 310 may include the rail shape with two lines spaced apart from each other by a predetermined distance that starts from a horizontal axis of a first side, arcs, and arrives at a horizontal axis of a second side. The first supplementing members 320 and the second supplementing members 330 in the supplementing frame 310 may form the truss structure to increase rigidity of the roof panel 100 around the reinforcing body 200, as illustrated in FIG. 10. The truss structure as described above may be formed to have a pair of first supplementing member 320 and second supplementing member 330 that intersect with each other to connect portions of the supplementing frame 310 to each other. For example, both end portions of the first supplementing member 320 may contact both end portions of the second supplementing member 330 at the supplementing frame 310, and may improve NVH and durability.

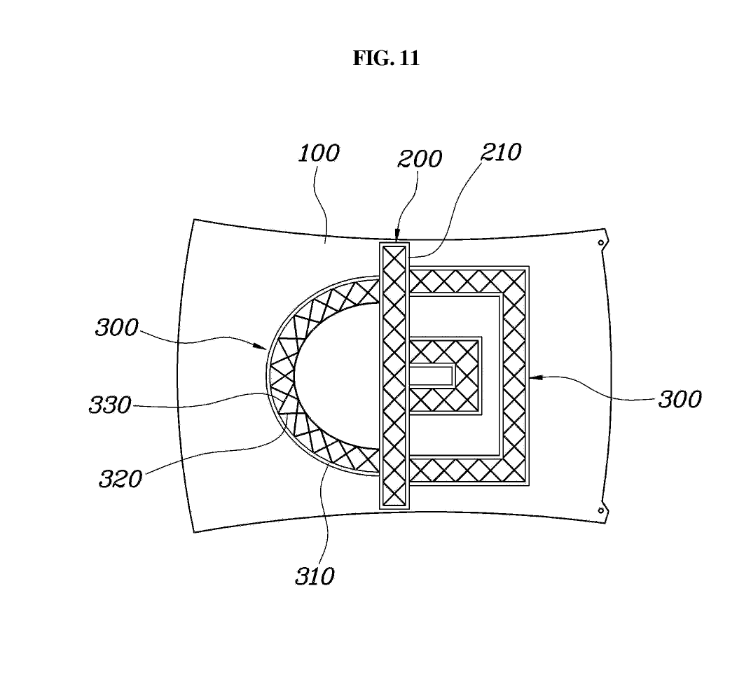

Additionally, as illustrated in FIG. 11, the supplementing body 300 including the supplementing frame 310 having the rail shape bent twice may be connected to the first side and the supplementing body 300 including the supplementing frame 310 having the rail shape arcing may be connected to the second side. In the roof for a vehicle according to the present invention as described above, the reinforcing body having the truss structure may be attached onto the lower surface of the roof panel formed of the composite material to secure the rigidity of the roof panel to improve NVH performance. The roof panel may be formed of a composite material that contains an insulating material to prevent a potential corrosion problem due to contact between the roof panel and a vehicle body formed of steel. A material of the roof panel may be changed from carbon fiber reinforced plastic (CI RP) into the insulating material The rigidity of the roof panel may be secured by reinforcement of the reinforcing body having the truss structure to decrease a thickness of the roof panel and to decrease a cost and a weight based on a change in a material and a thickness.

Although the present invention has been shown and described with respect to specific exemplary embodiments, it will be obvious to those skilled in the art that the present invention may be variously modified and altered without departing from the spirit and scope of the present invention as defined by the following claims

What is claimed is:

1. A roof for a vehicle, comprising:
a roof panel formed of a composite material;
a reinforcing frame coupled to a lower surface of the roof panel and formed of a composite material;
a plurality of first reinforcing members coupled to the reinforcing frame disposed within the reinforcing frame and continuously spaced apart from each other; and
a plurality of second reinforcing members that intersect the first reinforcing members, and are coupled to the reinforcing frame and disposed to be continuously spaced apart from each other to form a truss structure with the first reinforcing members within the reinforcing frame.

2. The roof for a vehicle of claim 1, wherein the reinforcing frame includes a pair of horizontal axes disposed adjacent to each other that extend in a width direction of the vehicle and a pair of vertical axes that each connect end portions of the pair of horizontal axes to each other.

3. The roof for a vehicle of claim 2, wherein the first reinforcing members connect the pair of horizontal axes to each other and form a predetermined angle with respect to the horizontal axes, and the second reinforcing members connect the pair of horizontal axes to each other while intersecting with the first reinforcing members.

4. The roof for a vehicle of claim 1, wherein the roof panel is formed of a composite material that contains an insulating material.

5. The roof for a vehicle of claim 1, wherein a thickness of a cross section of the reinforcing frame in a vertical direction is greater than the thickness of cross sections of the first and second reinforcing members in the vertical direction.

6. The roof for a vehicle of claim 5, wherein upper ends of the reinforcing frame, the first reinforcing member, and the second reinforcing member abut to the lower surface of the roof panel.

7. The roof for a vehicle of claim 3, wherein a pair of first and second reinforcing members intersecting with each other form a quadrangle together with a pair of adjacent surrounding first and second reinforcing members, and form a triangle with the horizontal axis and the vertical axis of the reinforcing frame.

8. The roof for a vehicle of claim 1, wherein the roof panel, the reinforcing frame, the first reinforcing members, and the second reinforcing members are integrally molded with each other.

9. The roof for a vehicle of claim 1, wherein the reinforcing frame, the first reinforcing members, and the second reinforcing members form a reinforcing body, and a plurality of reinforcing bodies are coupled to the lower surface of the roof panel in a length direction of the roof panel when the plurality of reinforcing bodies are spaced apart from each other.

10. The roof for a vehicle of claim 3, further comprising a supplementing body coupled to at least one of the pair of horizontal axes to supplement rigidity of the roof panel.

11. The roof for a vehicle of claim 10, wherein the supplementing body includes:
a first supplementing frame that forms a quadrangular shape together with the horizontal axis;
first supplementing members that intersect with each other to connect vertices of the supplementing frame to each other; and
second supplementing members that intersect with each other to connect sides of the supplementing frame to each other.

12. The roof for a vehicle of claim 10, wherein the supplementing body includes:
a supplementing frame that forms a semicircular shape together with the horizontal axis;
first supplementing members that radially extend from the center of the horizontal axis; and
second supplementing members that form a semicircular shape together with the horizontal axis, have a diameter less than that of the supplementing frame, and have a common center with the supplementing frame.

13. The roof for a vehicle of claim 10, wherein the supplementing body includes:
a supplementing frame with a first end portion connected to a first side of the horizontal axis and a second end portion connected to a second side of the horizontal axis and having a rail shape bent twice at a right angle;
a plurality of first supplementing members continuously spaced apart from each other to form a predetermined angle with respect to the horizontal axis along the supplementing frame within the supplementing frame; and
a plurality of second supplementing members continuously spaced apart from each other while intersecting the first supplementing members to form a truss structure together with the first supplementing members within the supplementing frame.

14. The roof for a vehicle of claim 10, wherein the supplementing body includes:
a supplementing frame with a first end portion connected to a first side of the horizontal axis and a second end portion connected to a second side of the horizontal axis and having an arch rail shape;
a plurality of first supplementing members connecting lines of the rail spaced apart from each other by a predetermined distance within the supplementing frame and disposed to be continuously spaced apart from each other along the supplementing frame; and
a plurality of second supplementing members continuously spaced apart from each other while intersecting with the first supplementing members to form a truss structure together with the first supplementing members within the supplementing frame.
